(19) United States
(12) Patent Application Publication
(10) Pub. No.: US 2026/0133131 A1
(43) Pub. Date: May 14, 2026

(54) OPTICAL SENSOR FOR DETECTING CAESIUM IONS AND/OR MEASURING CONCENTRATION OF THE SAME

(71) Applicant: Vulcan Photonics Sdn. Bhd., Kuala Lumpur (MY)

(72) Inventors: Khong Nee KOO, Ayer Itam (MY); Mei Qun SEAH, Subang Jaya (MY); Farah Hidayah Binti JAMALUDIN, Johor Bahru (MY)

(73) Assignee: Vulcan Photonics Sdn. Bhd., Kuala Lumpur, (MY)

(21) Appl. No.: 19/119,202

(22) PCT Filed: Oct. 10, 2022
(86) PCT No.: PCT/MY2022/050092

§ 371 Date: Apr. 8, 2025

(51) Int. Cl. G01N 21/77

(52) U.S. Cl. CPC G01N 21/7746; G01N 2021/7779; G01N 2021/7789

(57) ABSTRACT

The invention relates to an optical sensor for detecting Caesium ions and/or measuring concentration of the same in a fluid medium, comprising a resonant structure (1), a surface of which is covered by a layer of a macrocyclic compound (2). The invention further relates to a method for covering a surface of a resonant structure (1) of an optical sensor with a layer of a macrocyclic compound (2) such that the optical sensor is capable of detecting Caesium ions and/or measuring concentration of the same in a fluid medium.

This invention relates to an optical sensor for detecting Caesium ions and/or measuring concentration of the same, and a method for enabling the optical sensor in performing said functions.

### BACKGROUND OF THE INVENTION

Caesium (“Cs”) plays an increasingly important role worldwide, particularly in the fields of defence, aerospace, energy generation, electronics and medicine. As such demand for Cs in the international market grows significantly. Contrary to the utility that Cs offers, Cs being an alkali metal which is highly reactive, has a high fission yield and a long half-life, hence is toxic and detrimental to environment and human health. Among isotopes of Cs, ¹³⁷Cs poses the most severe threat to human health as it emits gamma radiation and has an extensive half-life of 30.17 years.

Researchers have been endeavouring to separate or remove ¹³⁷Cs from mediums which are contaminated by ¹³⁷Cs. A variety of materials and techniques have been introduced in methods for detecting or measuring Cs, e.g. Flame Atomic Absorption Spectrometry (“FAAS”), Inductively Coupled Plasma Mass Spectrometry (“ICP-MS”), Inductively Coupled Plasma Optical Emission Spectrometry (“ICP-OES”) and Ion Chromatography (“IC”). A relevant method of ICP-MS has been disclosed by Cao et al in a literature titled “Simultaneous determination of radiocesium (¹³⁵Cs, ¹³⁷Cs) and plutonium (²³⁹Pu, ²⁴⁰Pu) isotopes in river suspended particles by ICP-MS/MS and SF-ICP-MS”.

Nonetheless, the abovementioned methods suffer from a number of drawbacks which include requiring a sophisticated and expensive test equipment, complicated pre-processing of a sample, and/or requiring trained personnel for sample collection and result analysis. Said drawbacks further hinder the methods from being employed for on-site, in-situ measurement.

In a patent application no. CN113049573A, a ligand solution comprising a macrocyclic compound has been disclosed for the detection of Rubidium and Caesium ions. Although macrocyclic compounds have been known to be able to bind metal cations in a contaminated medium, there is a difficulty in coating a specific macrocyclic compound on a test structure, more especially on a compact test structure that can be employed for detecting Cs⁺ and measuring concentration of the same in an on-site, in-situ manner.

### SUMMARY OF THE INVENTION

The above-mentioned drawbacks and difficulty are overcome by the invention elaborated in the paragraphs that follow.

One aspect of the invention provides an optical sensor for detecting Caesium ions and/or measuring concentration of the same in a fluid medium, comprising a resonant structure, a surface of at least a part of which is covered by a layer of a macrocyclic compound, characterised in that said macrocyclic compound is brominated dibenzo-24-crown-8, the material index of which changes in accordance with the amount of Caesium ions bound thereby.

Advantageously brominated dibenzo-24-crown-8is an ionophore capable of chemically binding Caesium ions in the medium, such that the consequential change in the material index can be detected and/or measured.

Advantageously the resonant wavelength of said resonant structure shifts in accordance to the change in the material index.

In one embodiment, said resonant structure comprises a test waveguide and a reference waveguide, said test waveguide being exposable to the medium, and said reference waveguide being sealed from any contact with the medium. Typically the resonant structure is formed in silicon or silicon dioxide.

In one embodiment, a light source is configured to emits light of at least one wavelength which is directed through said test and reference waveguides, the shift in resonant wavelength being determined by comparing the patterns generated from the respective test and reference waveguides, said shift corresponding to the concentration of Caesium ions in the medium. Advantageously the comparison allows shifts of <500 pm to be measured accurately, enabling a sensitivity down to 10 ppb Caesium ions.

In yet another embodiment, the optical sensor also comprises a spectral interrogator, connected to the outputs of said test and reference waveguides, capable of providing a reading in wavelength or phase of the light.

Typically, each of said test and reference waveguides is of 15-1000 nm in width and 200 μm to 1 cm in length.

Typically, the light source comprises at least one laser source, and is capable of emitting light at a wavelength ranging from 1500 to 1600 nm. Typically the laser source is able sweep through and emit light of the aforementioned wavelength range in less than a second.

Typically, during the test said exposable resonant structure is exposed to the medium for a time interval of 30 seconds to 2 minutes.

In yet another embodiment, the optical sensor also comprises a pair of multi-mode interferometers, one of which is connected to an input end of said resonant structure for diverging the light, and the other one is connected to output end of said resonant structure for converging the light.

In yet another embodiment, the optical sensor also comprises: a silicon slab interposer and a spot size converter connected to said multi-mode interferometer at the input end; and a waveguide, an input of which is connected to the light source, and output of which is connected to said silicon slab interposer.

In yet another embodiment, said spectral interrogator comprises: a pair of multi-mode-interferometer-based reflectors and two pairs of micro-ring resonators.

Typically, the resonant wavelength of said resonant structure shifts over time as said macrocyclic compound is exposed to a medium with a composition of different metal ions.

Typically said shift of resonant wavelength is a superimposition of the curves of resonant wavelength versus time for each metal ion in the composition, wherein said superimposition is usable in training an artificial neural network to determine presence of Caesium ions and/or concentration of the same in a medium.

Advantageously said macrocyclic compound has unique kinetics in absorbing Caesium ions, hence causes the resonant structure to provide a distinct curve of resonant wavelength versus time as said macrocyclic compound is exposed to a medium with a concentration of Caesium ions, wherein said distinct curve is useable for identifying Caesium ions and/or measuring concentration of the same, in the medium.

Another aspect of the invention provides a method for covering a surface of a resonant structure of an optical sensor with a layer of a macrocyclic compound such that the sensor is capable of detecting Caesium ions and/or measuring concentration of the same in a fluid medium, comprising the steps of: performing plasma treatment on the surface using oxygen gas; and treating the surface using a 2% (v/v) 3-Aminopropyltriethoxysilane (APTES) solution diluted in pure ethanol, at room temperature for a first predetermined time interval characterised by treating the surface using 50 ml of 100 mM brominated dibenzo-24-crown-8 (BDB24C 8) solution diluted in a solvent; and leaving the surface undisturbed for the solvent in the BDB24C8 solution to evaporate, such that the layer of macrocyclic compound is formed on the surface.

Typically, the macrocyclic compound is brominated dibenzo-24-crown-8.

brominated dibenzo-24-crown-8is an ionophore capable of chemically binding Caesium ions in the medium, such that material index of the brominated dibenzo-24-crown-8is changed in accordance with amount of Caesium ions bound thereby. In one embodiment, the method also comprises steps of: drying the surface at 80° C. for the first predetermined time interval; and treating the surface using a 0.1% (v/v) glutaraldehyde (GA) solution diluted in deionized water, at room temperature for a second predetermined time interval.

Typically, the first predetermined time interval is 1 hour, and the second predetermined time interval is 20 minutes.

Typically, the solvent is methanol.

Typically, the optical sensor comprises a Mach-Zehnder interferometer.

Yet another aspect of the invention provides an optical sensor fabricated by the above-mentioned method.

Advantageously resonant wavelength of said resonant structure shifts in accordance to the change in the material index.

Typically, the resonant wavelength of said resonant structure shifts over time as said macrocyclic compound is exposed to a medium with a composition of different metal ions, said shift of resonant wavelength being a superimposition of the curves of resonant wavelength versus time for each metal ion in the composition, wherein said superimposition is usable in training an artificial neural network to determine presence of Caesium ions and/or concentration of the same in a medium.

Advantageously said macrocyclic compound has unique kinetics in absorbing Caesium ions, hence causes the resonant structure to provide a distinct curve of resonant wavelength versus time as said macrocyclic compound is exposed to a medium with a concentration of Caesium ions, wherein said distinct curve is useable for identifying Caesium ions and/or measuring concentration of the same, in the medium.

### DESCRIPTION OF THE PREFERRED EMBODIMENT

The invention will now be described in greater detail, by way of example, with reference to the accompanying drawing, in which:

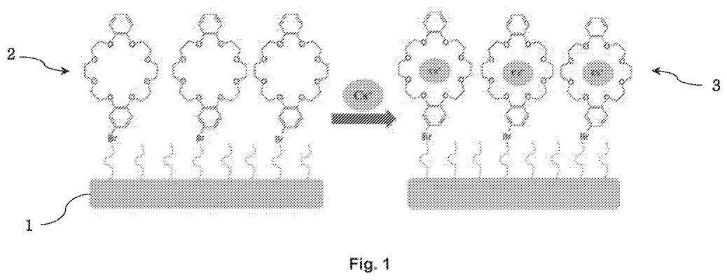

FIG. 1 shows the mechanism, according to the invention, by which Caesium cations are captured by a layer of macrocyclic compound coated on the surface of a resonant structure;

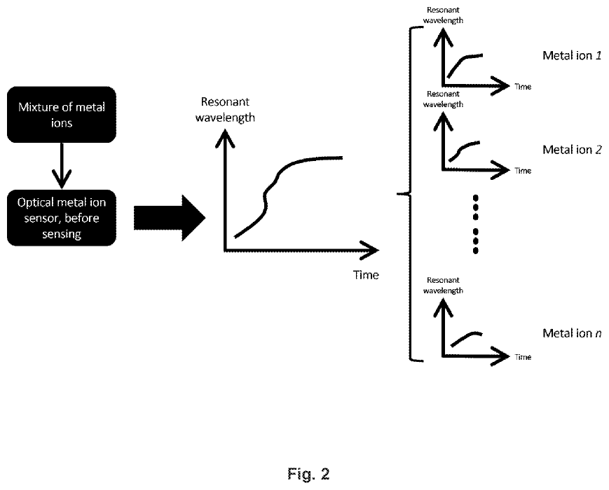

FIG. 2 shows that the resonant wavelength of said resonant structure shifts over time as said macrocyclic compound is exposed to a medium with a composition of different metal ions;

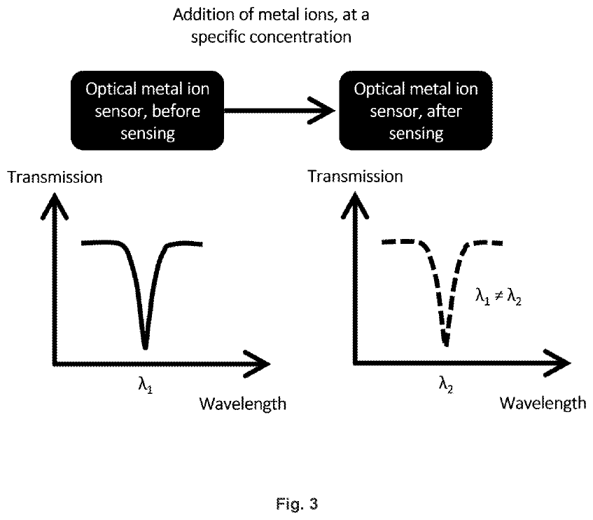

FIG. 3 shows a wavelength of the optical wave, higher than that when the resonant structure is not coated with the layer of macrocyclic compound, is required to cause the resonant structure to resonate;

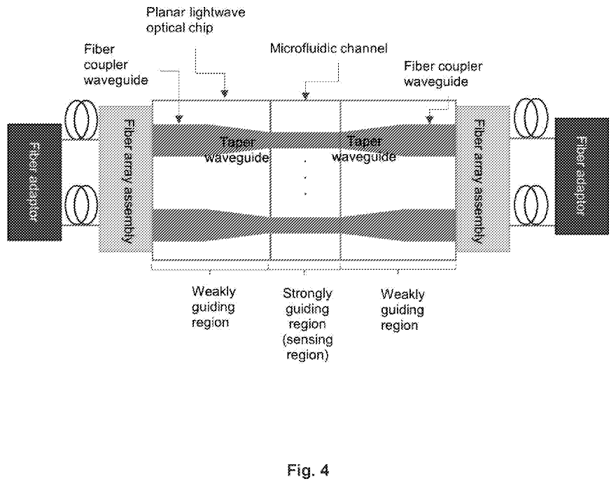

FIG. 4 is a plan view of a dielectric planar light-wave circuit (PLC) with waveguide sections of different widths;

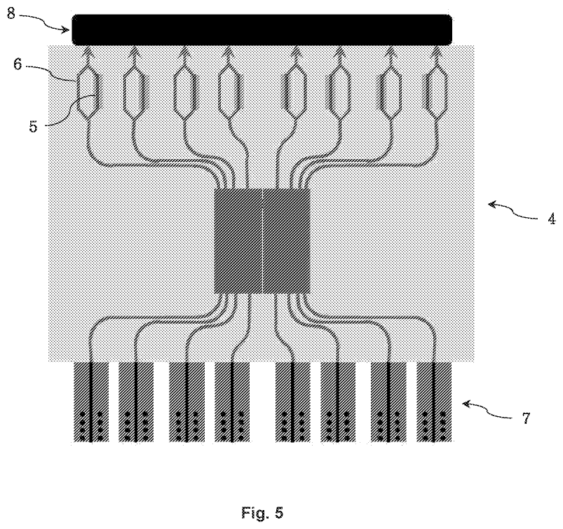

FIG. 5 is top view of a sensor chip, input of which is connected to a laser source and output of which is connected to a spectral interrogator;

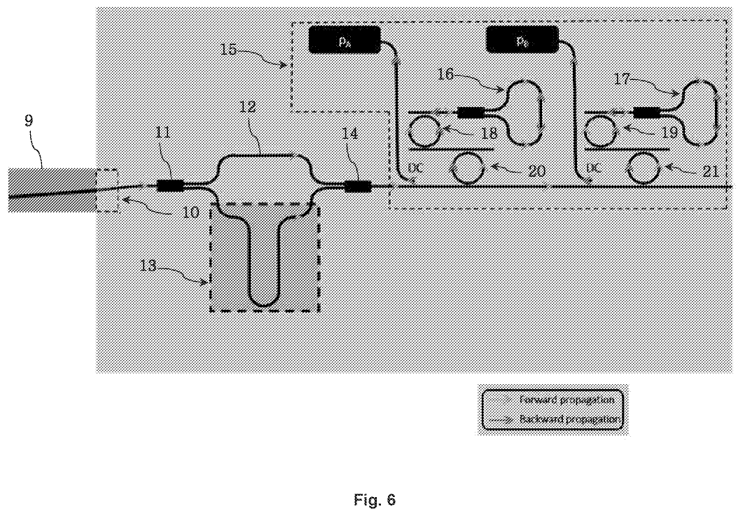

FIG. 6 is top view of a Mach-Zehnder interferometer system constructed on a silicon on insulator platform; and

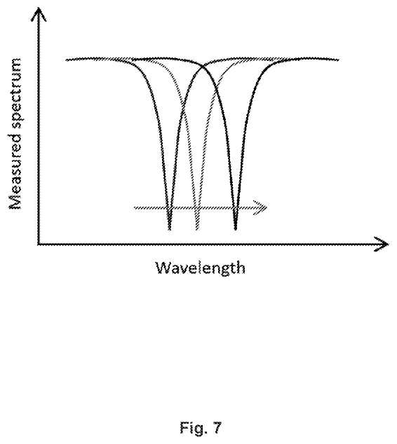

FIG. 7 is a graph of transmission versus resonant wavelength showing shifts of the resonant wavelength as the concentration of Cs⁺ in a medium is increased.

Certain macrocyclic compound serves as an effective binding site for Cs cations (“Cs⁺”), hence can be used for the separation or removal of Cs⁺ from a contaminated medium. The ability to bind Cs⁺ attributes to a good match between the cavity of the macrocyclic compound and the ionic radius of the Cs⁺. Factors which effect recognition of the Cs⁺, and stability and selectivity of the recognition, include the cavity dimension, shape, substituent effect, conformational flexibility, type of donor atom, and the solvent of the macrocyclic compound. A macrocyclic compound capable of binding Cs⁺ provides a cavity that a Cs⁺ closely fits into, and a set of oxygen atoms capable of arranging around the Cs⁺ in a nearly planar manner, hence yields a promising result in selectively separating Cs⁺ from mediums such as complex water and nuclear waste solution.

Referring to FIG. 1, one form of the optical sensor, which can be a Mach-Zehnder interferometer, comprises a resonant structure 1, e.g. a waveguide, the surface of which is coated by a layer of macrocyclic compound 2, i.e. brominated dibenzo-24-crown-8 (“BDB24C8”). BDB24C8 is an ionophore capable of chemically binding Cst in a fluid medium, e.g. liquid or gas, and forming a complex 3 consisting of BDB24C8 and Cs⁺.

The method for coating surface of the resonant structure 1 with the layer of macrocyclic compound 2 comprises the following steps. First, for the purpose of hydroxylating the surface, a plasma treatment is performed on the surface using oxygen gas. Then the surface is treated using a 2% (v/v) 3-Aminopropyltriethoxysilane (“APTES”) solution diluted in pure ethanol, at a room temperature for 1 hour. Subsequently, the surface is completely dried at 80° C. for 1 hour, after which the surface is treated using a 0.1% (v/v) glutaraldehyde (“GA”) solution diluted in deionized water, at a room temperature for 20 minutes. The surface is then treated using 50 ml of 100 mM brominated dibenzo-24-crown-8 (“BDB24C8”) solution diluted in a solvent, i.e. methanol. Last, the surface is left undisturbed for the solvent in the BDB24C8 to evaporate, such that the layer of macrocyclic compound 2, i.e. BDB24C8, is formed or immobilized on the surface. The coated resonant structure 1 is functionalized by BDB24C8 which acts as a ligand for Cs⁺, hence can detect monovalent cations of Cs. When the coated resonant structure 1 is exposed to a medium which carries Cs⁺, the material index of the BDB24C8 is changed in accordance with the amount of Cs⁺ bound by the BDB24C8.

A wider range of detection for Cs⁺ can be achieved when the concentration of the BDB24C8 immobilized on the surface is increased. As such the concentration of the BDB24C8 can be adjusted to optimize said detection range in accordance with a test requirement.

As the layer of BDB24C8 is heterogeneously integrated with the resonant structure 1, a change in the material index modifies the resonant condition of the surface of the resonant structure. As shown in FIG. 2, the resonant wavelength of the resonant structure shifts over time as said macrocyclic compound is exposed to a medium with a composition of different metal ions, said shift of resonant wavelength being a superimposition of the curves of resonant wavelength versus time for each metal ion in the composition. The superimposition is usable in training an artificial neural network to determine presence of Caesium ions and/or concentration of the same in a medium. Said macrocyclic compound has unique kinetics in absorbing Caesium ions, hence causes the resonant structure to provide a distinct curve of resonant wavelength versus time as said macrocyclic compound is exposed to a medium with a concentration of Caesium ions. Said distinct curve is useable for identifying Caesium ions and/or measuring concentration of the same, in the medium.

The higher the concentration of the Caesium ions, the faster the resonant structure achieves the maximum resonant wavelength corresponding to said concentration. A material index is a grouping of material properties which affect the characteristic of the layer. The properties include relative dielectric constant, thermal resistivity (° C. cm/W), and loss tangent. For a silicon photonics sensor, the material index is usually the refractive index.

Resonance can be defined as a vibration of large amplitude in a mechanical, electrical or optical system caused by a relatively small periodic stimulus of the same or nearly the same period as the natural vibration of the system.

For the optical sensor, resonance occurs at its resonant structure, and the periodic stimulus is an optical wave of a specific wavelength. The specific wavelength is known as the resonant wavelength, namely a wavelength of the optical wave by which the resonant structure is caused to resonate.

The addition of a macrocyclic compound layer to the surface of the resonant structure changes the condition under which the resonant structure resonates. As shown in FIG. 3, a wavelength of the optical wave, higher than that when the resonant structure is not coated with the layer of macrocyclic compound, is required to cause the resonant structure to resonate. As the concentration of the Cs⁺ increases, the material index of the layer of macrocyclic compound changes, and the resonant wavelength of the resonant structure increases accordingly.

The resonant structure is an essential part of the optical sensor where the macrocyclic compound is capable of influencing the wavelength of the light passing through the structure. As the light passes through the structure, an electric field travels beyond the wall of the structure as evanescent field. The evanescent field is susceptible to the surrounding, hence is easily influenced by the layer of macrocyclic compound residing on the outer surface of the structure. As the material index of the macrocyclic compound changes due to the absorption of the Cs⁺, the evanescent field is affected by the changes, and the resonant wavelength of the light passing through the structure increases accordingly.

Referring to FIG. 4, the optical sensor can be a dielectric planar light-wave circuit (“PLC”) with waveguide sections of different widths, typically arranged in pairs. Each end of the PLC has a fibre array assembly, to which a fibre adaptor is connected. The fibre adaptor adapts an optical fibre to the PLC and vice versa. Said circuit can be mass-produced by a semiconductor wafer process. At least one of the waveguide sections is coated with the layer of macrocyclic compound. This coated waveguide section functions as a resonant structure of the PLC.

Referring to FIG. 5, multiple PLCs can be deployed on a sensor chip 4 of a scale of one or more mm². For each PLC, one of the waveguide sections is exposed 5, while the other one is sealed 6 from any contact with a medium (or is not coated with the macrocyclic compound). During a test, the exposed section 5 provides a wavelength pattern corresponding to the concentration of Cs⁺ in the medium, whereas the sealed section 6 provides a reference wavelength pattern corresponding to a condition in which Cs⁺ is of non-existence. The input of the PLC is connected to a plurality of laser sources 7, and the output of the PLC is connected to spectral interrogator 8 which functions as the detector for Cs⁺.

Referring to FIG. 6, the resonant structure can also be deployed in a Mach-Zehnder interferometer (“MZI”) system which is constructed on a silicon-on-insulator (“SOI”) platform. Input of the MZI system is a III-V waveguide 9 which is connected to a silicon slab interposer and spot size converter (“SSC”) 10. The interposer has a silicon dioxide SiO₂ cladding, and is of 6 μm in width and 0.07 μm in thickness. Output of the interposer and SSC is coupled to a 1×2 multi-mode interferometer (“MMI”) 11, output of which is diverged to an unbalanced MZI 12 and waveguide sensing section 13, latter of which is the resonant structure having a surface coated with a layer of BDB24C8. The waveguide sensing section 13 has a silicon dioxide SiO₂ cladding, and is of 15-1000 nm in width, 220 nm in thickness and 200 μm to 1 cm in length. The other ends of the unbalanced MZI 12 and waveguide sensing section 13 converge to a 2×1 MMI 14 which couples them to an interrogator 15 fully integrated in the system. The MMIs 11, 14 deployed at said two ends are vertical grating couplers in which transverse mode (“TM”) is preferred. The interrogator 15 comprises a pair of MMI-based reflectors 16, 17 and 2 pairs of micro-ring resonators (“MRR”) 18, 19, 20, 21. The MZI system provides a readout parameter in phase or lambda (i.e. wavelength), a wavelength range of 1500 to 1600 nm, and a resolution of 1 pm at the minimum.

The following sequence may be observed when a test is implemented with the MZI system. First, a drop of distilled water is added as a blank sample on the surface of the MZI system. Second, the droplet of distilled water is removed from the surface. Third, a drop of solution having a known concentration of Cs⁺ is added on the surface. After 30 seconds to 2 minutes, the solution is removed from the surface. Then, a drop of distilled water is again added to the surface. Last but not least, the laser is swept from a wavelength of 1500 to 1600 nm, and the output of the sensor is measured.

Referring to FIG. 7, the output of the sensor can be shown in a graph of transmission versus resonant wavelength. As the concentration of Cs⁺ increases, the resonant wavelength tends to shift to the right, i.e. becomes higher. The shift may be up to 500 pm or more, and has been experimentally observed to be in a range of 340 to 430 pm, which can be used to identify presence of the Cs⁺ and measure its concentration in a medium.

The above-mentioned method is relatively simple, but produces an optical sensor highly sensitive and selective in its ability to detect Cs⁺ in an aqueous or non-aqueous environment from 10 ppb up to 200 ppm. Compared to an ICP-MS or ICP-OES approach, a plurality of BDB24C8-coated resonant structures, e.g. mirroring resonators, disposed in a photonic platform, e.g. Mach-Zehnder interferometer, have a much smaller footprint. Despite the smaller footprint, the optical sensor is capable of detecting Cs⁺ and measuring concentration of the same accurately.

Moreover, the above-mentioned method employs non-toxic solvents. The optical sensor fabricated by the method, being compact, can be employed for on-site, in-situ detection and measurement of Cs⁺, hence is of a huge commercial value, particularly in the fields of nuclear and water quality monitoring industries.

It will be appreciated by persons skilled in the art that the present invention may also include further additional modifications which does not affect the overall functioning thereof.

1. An optical sensor for detecting Caesium ions and/or measuring concentration of the same in a fluid medium, comprising:
a resonant structure (1), a surface of at least a part of which is covered by a layer of a macrocyclic compound,
characterised in that said macrocyclic compound is brominated dibenzo-24-crown-8, the material index of which changes in accordance with the amount of Caesium ions bound thereby.

2. An optical sensor as claimed in claim 1, wherein brominated dibenzo-24-crown-8 is an ionophore capable of chemically binding Caesium ions in the medium, such that the resonant wavelength of said resonant structure (1) shifts over time in accordance with the consequential change in the material index, and such shift can be detected and/or measured.

3. An optical sensor as claimed in claim 2, wherein said resonant structure comprises a test waveguide (5) and a reference waveguide (6), said test waveguide (5) being exposable to the medium, and said reference waveguide (6) being sealed from any contact with the medium.

4. An optical sensor as claimed in claim 3, wherein a light source is configured to emit light of at least one wavelength which is directed through said test and reference waveguides, the shift in resonant wavelength being determined by comparing the patterns generated from the respective test and reference waveguides, said shift corresponding to the concentration of Caesium ions in the medium.

5. An optical sensor as claimed in claim 4, also comprising a spectral interrogator (8), connected to outputs of said test and reference waveguides (5, 6), capable of providing a reading in wavelength or phase of the light.

6. An optical sensor as claimed in claim 5, wherein each of said test and reference waveguides (5, 6) is of 15-1000 nm in width and 200 μm to 1 cm in length.

7. An optical sensor as claimed in claim 6, wherein the light source (7) comprises at least one laser source, and is capable of emitting light at a wavelength ranging from 1500 to 1600 nm.

8. An optical sensor as claimed in claim 5, wherein during the test said test waveguide (5) is exposed to the medium for a time interval of 30 seconds to 2 minutes.

9. An optical sensor as claimed in claim 8, also comprising a pair of multi-mode interferometers (11, 14), one of which is connected to an input end of said resonant structure (1) for diverging the light, and the other is connected to an output end of said resonant structure (1) for converging the light.

10. An optical sensor as claimed in claim 9, also comprising:
a silicon slab interposer and a spot size converter (10) connected to said multi-mode interferometer (11) at the input end; and
a waveguide (9), an input of which is connected to the light source, and output of which is connected to said silicon slab interposer.

11. An optical sensor as claimed in claim 10, wherein said spectral interrogator comprises: a pair of multi-mode-interferometer-based reflectors (16, 17) and two pairs of micro-ring resonators (18, 19, 20, 21).

12. A method for covering a surface of a resonant structure (1) of an optical sensor with a layer of a macrocyclic compound (2) such that the sensor is capable of detecting Caesium ions and/or measuring concentration of the same in a fluid medium, comprising steps of:
performing plasma treatment on the surface using oxygen gas; and
treating the surface using a 2% (v/v) 3-Aminopropyltriethoxysilane (APTES) solution diluted in pure ethanol, at room temperature for a first predetermined time interval;
characterised by treating the surface using 50 ml of 100 mM brominated dibenzo-24-crown-8 (BDB24C8) solution diluted in a solvent; and
leaving the surface undisturbed for the solvent in the BDB24C8 solution to evaporate, such that the layer of macrocyclic compound (2) is formed on the surface.

13. A method as claimed in claim 12, wherein the macrocyclic compound is brominated dibenzo-24-crown-8 and the material index thereof changes in accordance with the amount of Caesium ions bound thereby.

14. A method as claimed in claim 13, also comprising steps of:
drying the surface at 80° C. for the first predetermined time interval; and
treating the surface using a 0.1% (v/v) glutaraldehyde (GA) solution diluted in deionized water, at room temperature for a second predetermined time interval.

15. A method as claimed in claim 14, wherein the first predetermined time interval is 1 hour, and the second predetermined time interval is 20 minutes.

16. A method as claimed in claim 14, wherein the solvent is methanol.

17. A method as claimed in claim 14, wherein the optical sensor comprises a Mach-Zehnder interferometer.
